(19) United States
(12) Patent Application Publication
(10) Pub. No.: US 2009/0310929 A1
(43) Pub. Date: Dec. 17, 2009

(54) OPTICAL FIBER INTERCONNECTION APPARATUS

(75) Inventors: Jacob E. Reinhardt, Minneapolis, MN (US); Matthew A. Willms, Woodbury, MN (US); Trevor D. Smith, Eden Prairie, MN (US); Raymond Hagen, Apple Valley, MN (US)

Correspondence Address: MERCHANT & GOULD PC, P.O. BOX 2903, MINNEAPOLIS, MN, 55402-0903, US

(73) Assignee: ADC TELECOMMUNICATIONS, INC., Eden Prairie, MN (US)

(21) Appl. No.: 12/249,017

(22) Filed: Oct. 10, 2008

Related U.S. Application Data
(60) Provisional application No. 60/998,571, filed on Oct. 10, 2007.

(51) Int. Cl. G02B 6/00

(52) U.S. Cl. 385/135

(57) ABSTRACT

A fiber optic interconnection apparatus includes a chassis; and at least one splice shelf pivotally mounted within the chassis. The splice shelf is pivotally movable from a stowed position within the chassis to an accessed position where the splice shelf is positioned at least partially outside the chassis. The splice shelf includes a splice tray support pivotally connected to the chassis and a splice tray that removably mounts to the splice tray support. The splice tray includes a tray body to which fiber optic adapters are mounted. The splice tray also includes a splice sleeve holder mounted to the tray body.

### CROSS-REFERENCE

This application claims the benefit of U.S. Provisional Application Ser. No. 60/998,571, filed Oct. 10, 2007, which application is hereby incorporated by reference herein.

### TECHNICAL FIELD

The present disclosure relates generally to optical fiber telecommunications systems. More particularly, the present disclosure relates to devices, such as fiber panels, for use in interconnecting optical fibers.

### BACKGROUND

Optical networks are becoming prevalent in part because service providers want to provide high bandwidth communication capabilities to customers. A typical optical network includes equipment, such as fiber interconnection panels, that are configured for readily allowing optical fibers to be efficiently connected together. A typical fiber interconnection panel includes a plurality of fiber optic adapters suitable for providing optical connections between two fiber optic connectors. Often, fiber interconnection panels are used in combination with patch cords to provide cross-connections between different pieces of telecommunication equipment. Also, fiber interconnection panels can be used to provide fiber optic connections between fibers carried by an outside plant cable and fibers optically coupled to pieces of telecommunications equipment. Fiber interconnection panels can be located at inside (e.g., a service provider central office) or outside environments (e.g., without an outside cabinet).

### SUMMARY

Certain aspects of this disclosure relate to fiber optic interconnection devices having features that enhance cable management and the ability to provide efficient splicing while minimizing space usage.

A variety of additional aspects will be set forth in the description that follows. Aspects can relate to individual features and to combinations of features. It is to be understood that the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is the front, perspective view of a fiber optic interconnection apparatus in accordance with the principles of the present disclosure;

FIG. 2 shows the fiber optic interconnection apparatus of FIG. 1 with a front door pivoted open;

FIG. 3 shows the fiber optic interconnection apparatus of FIG. 1 with a splice shelf pivoted to an accessed position;

FIG. 4 is a top view of the fiber optic interconnection apparatus of FIG. 1;

FIG. 5 is a front view of the fiber optic interconnection apparatus of FIG. 1;

FIG. 6 is a side view of the fiber optic interconnection apparatus of FIG. 1;

FIG. 7 is a top view of the fiber optic interconnection apparatus of FIG. 1 with the splice shelf pivoted to the accessed position;

FIG. 8 is a front view of the fiber optic interconnection apparatus of FIG. 1 with the splice shelf pivoted to the accessed position;

FIG. 9 is a side view of the fiber optic interconnection apparatus of FIG. 1 with the splice shelf pivoted to the accessed position;

FIG. 10 is a top view of the fiber optic interconnection apparatus of FIG. 1 with the top removed and the splice shelf oriented in a stowed position;

FIG. 11 is a top view of the splice shelf of the fiber optic interconnection apparatus of FIG. 1;

FIG. 12 is a front view of the splice shelf of FIG. 11;

FIG. 13 is a bottom view of the splice shelf of FIG. 11;

FIG. 14 is a perspective view of the splice shelf of FIG. 11;

FIG. 15 is an exploded view of the splice shelf of FIG. 11 showing a splice tray of the splice shelf removed from a splice tray support of the splice shelf;

FIG. 16 is a perspective view of a fiber optic adapter suitable for use with the splice shelf of FIG. 11;

FIG. 17 is a cross-sectional view taken lengthwise through the fiber optic adapter of FIG. 16;

FIG. 18 schematically shows an example cable routing scheme for the fiber optic interconnection apparatus of FIG. 1;

FIG. 19 shows another fiber optic interconnection apparatus in accordance with the principles of the present disclosure;

FIG. 20 shows the fiber optic interconnection apparatus of FIG. 19 with a front door pivoted open;

FIG. 21 shows the fiber optic interconnection apparatus of FIG. 19 with a splice shelf pivoted to an accessed position;

FIG. 22 is a top view of the fiber optic interconnection apparatus of FIG. 19;

FIG. 23 is a front view of the fiber optic interconnection apparatus of FIG. 19;

FIG. 24 is a side view of the fiber optic interconnection apparatus of FIG. 19;

FIG. 25 is a top view of the fiber optic interconnection apparatus of FIG. 19 with the splice shelf pivoted to the accessed position;

FIG. 26 is a front view of the fiber optic interconnection apparatus of FIG. 19 with the splice shelf pivoted to the accessed position;

FIG. 27 is a side view of the fiber optic interconnection apparatus of FIG. 19 with the splice shelf pivoted to the accessed position; and

FIG. 28 is a top view of the fiber optic interconnection apparatus of FIG. 19 with the splice shelf shown in hidden line at a stowed position within the fiber optic interconnection apparatus.

### DETAILED DESCRIPTION

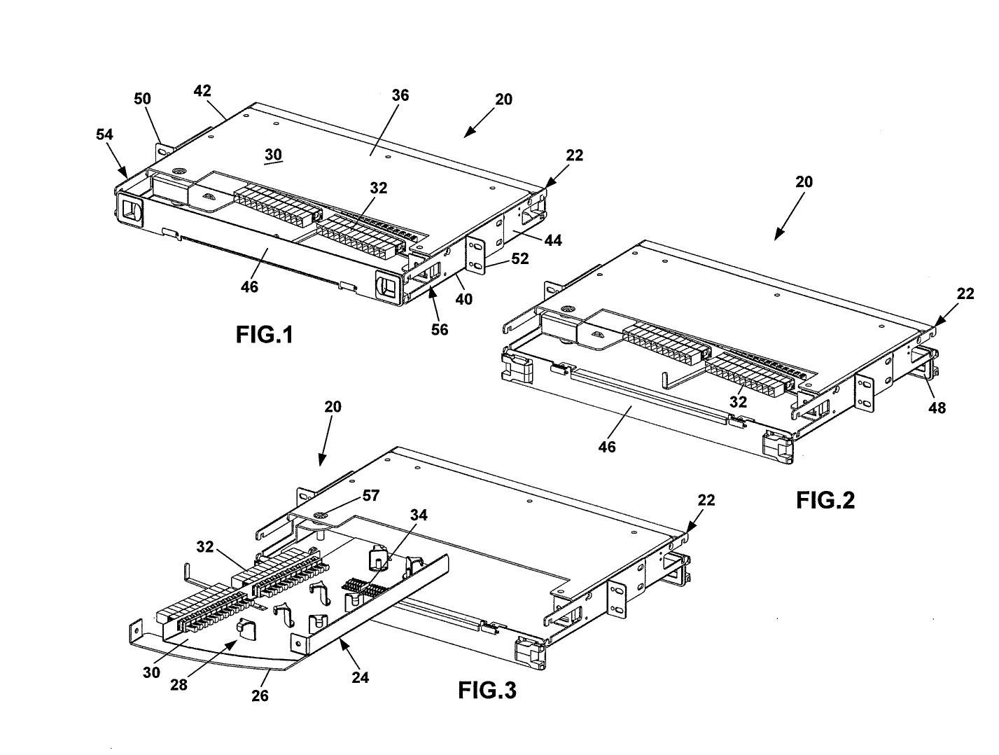

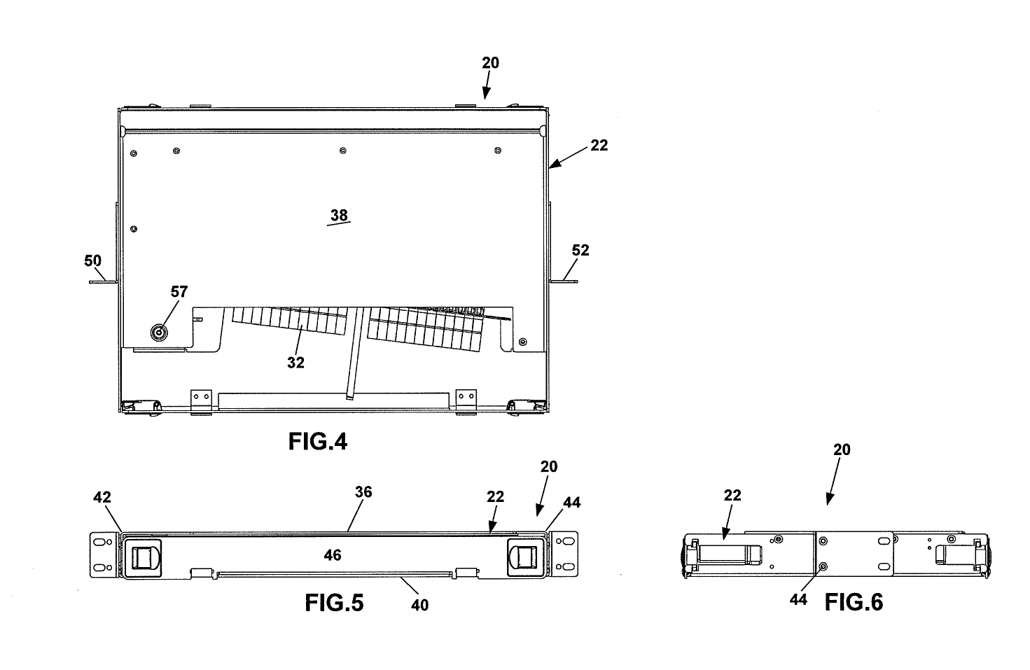

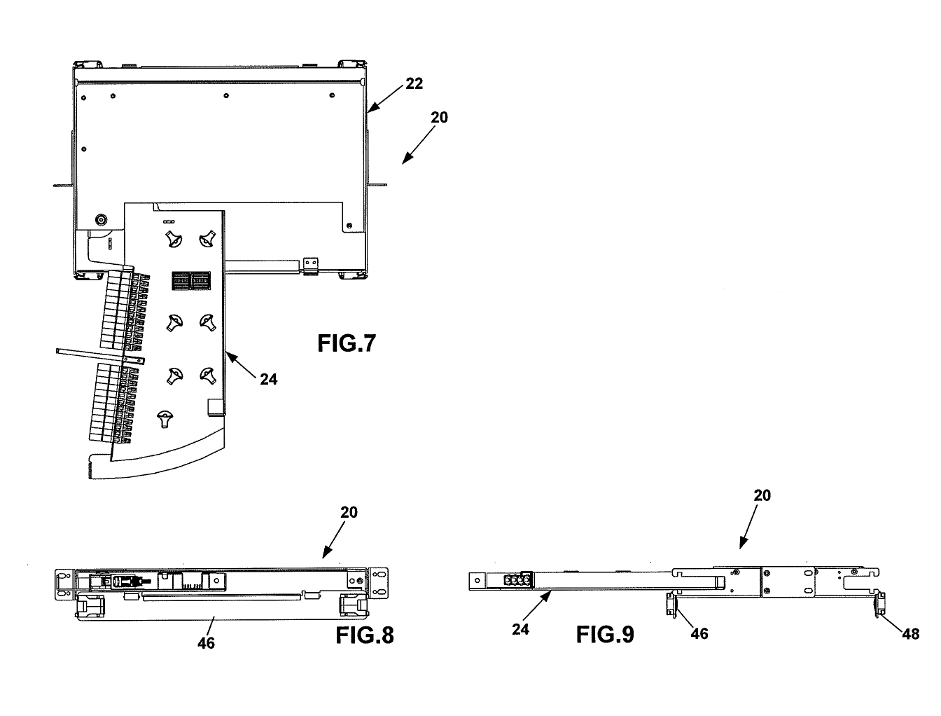

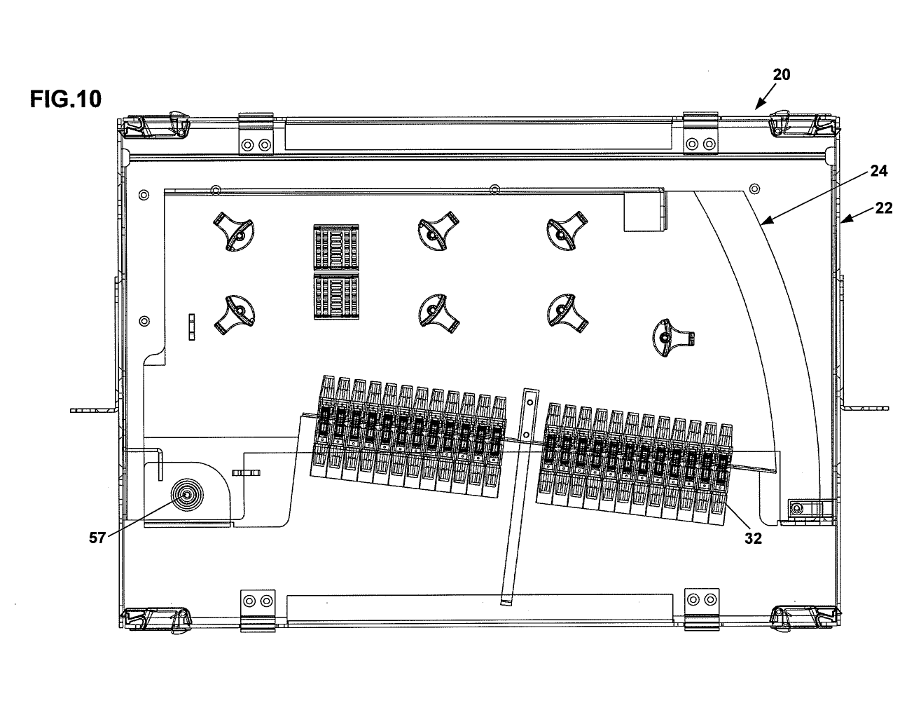

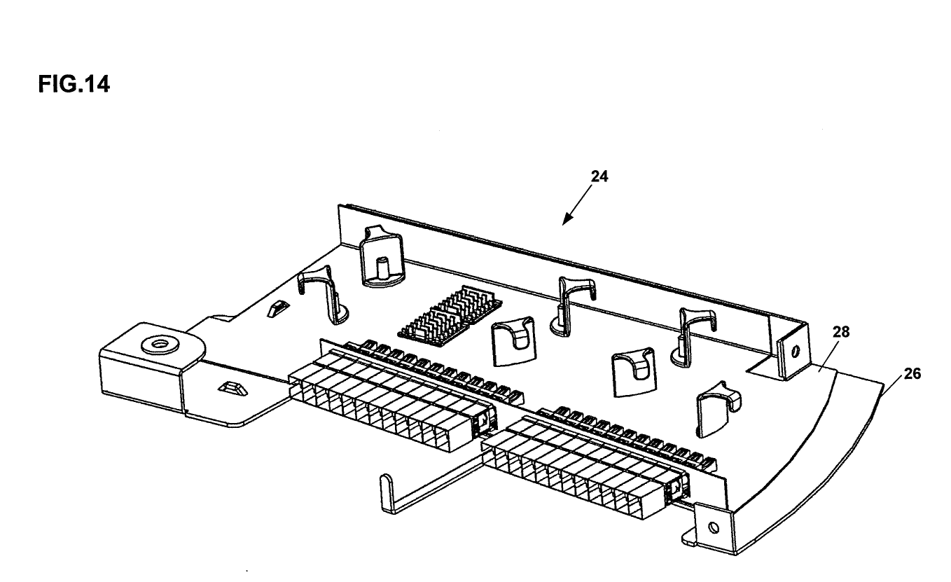

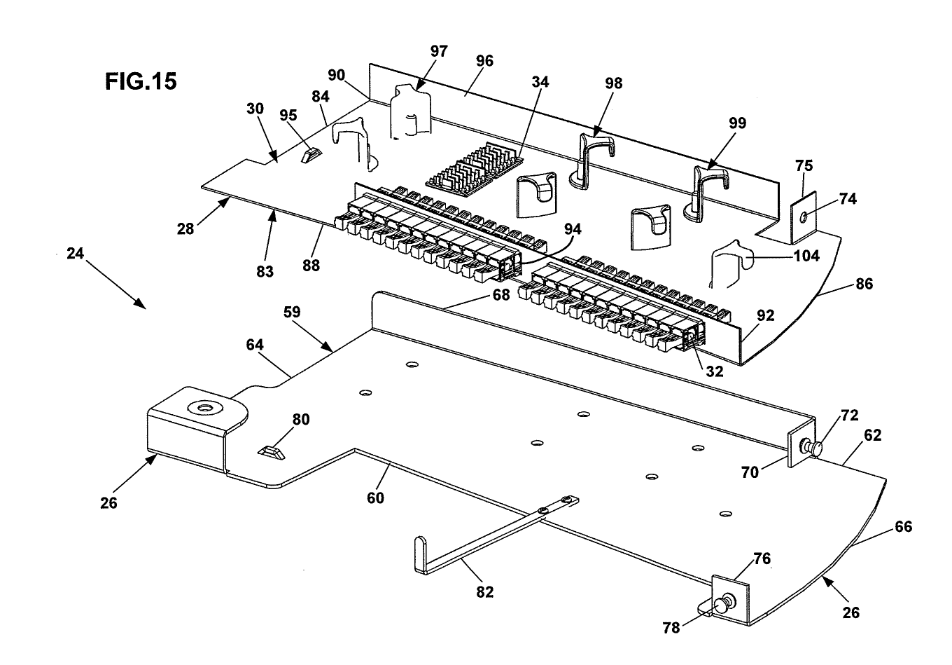

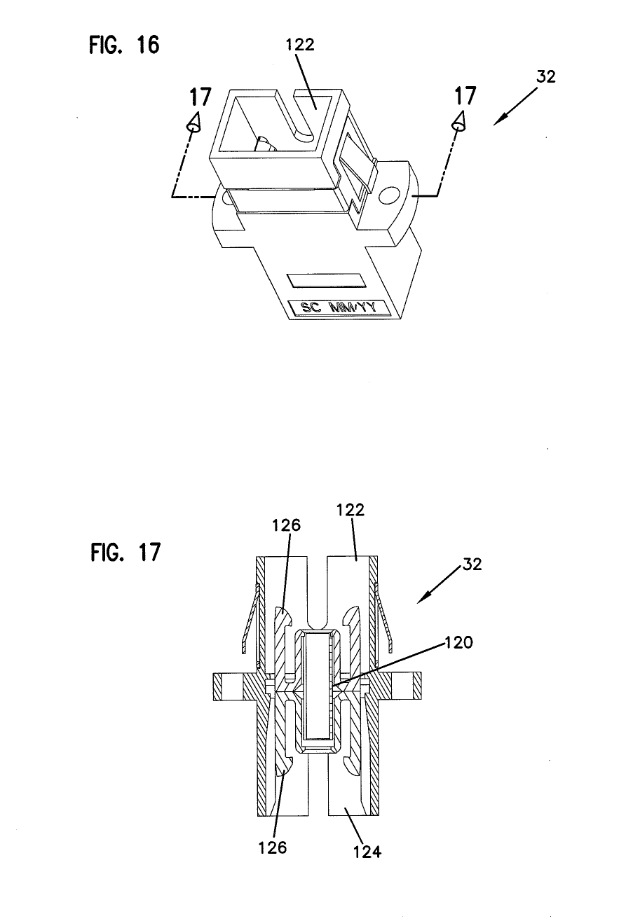

FIGS. 1-15 show a fiber optic interconnection apparatus 20 in accordance with the present disclosure. Generally, the fiber optic interconnection apparatus 20 includes a chassis 22 adapted to be mounted to a structure such as a telecommunications rack. The chassis 22 functions to enclose or protect a splice shelf 24. The splice shelf 24 is pivotally connected to the chassis 22 and is movable between a stowed position (see FIG. 2) and an accessed position (see FIG. 3). The splice shelf 24 includes a splice tray support 26 pivotally mounted to the chassis 22, and a splice tray 28 supported on the splice tray support 26. The splice tray 28 includes a tray body 30 that is removably mounted to the splice tray support 26 (see FIG. 15). The splice tray 28 further includes a plurality of fiber optic adapters 32 mounted to the tray body 30. Additionally, the splice tray 28 includes cable management structure and a splice sleeve holder 34 mounted to the tray body 30.

Referring still to FIGS. 1-15, the chassis 22 of the fiber optic interconnection apparatus 20 includes a main body 36 having a generally rectangular, envelope style configuration sized to correspond with one rack unit height of a conventional telecommunications rack. The main body 36 includes a top side 38, a bottom side 40, a left side 42 and a right side 44. Front and rear sides of the main body 36 are open. The chassis 22 further includes a front door 46 for opening and closing the front side of the main body 36 and a rear door 48 for opening and closing the rear side of the main body 36. The chassis 22 further includes left and right flanges 50, 52 for attaching the fiber optic interconnection apparatus 20 to a rack, and left and right sets of cable management bars 54, 56 that project forwardly from the front side of the main body 36. The front and rear doors 46, 48 include latches for retaining each door in a closed position.

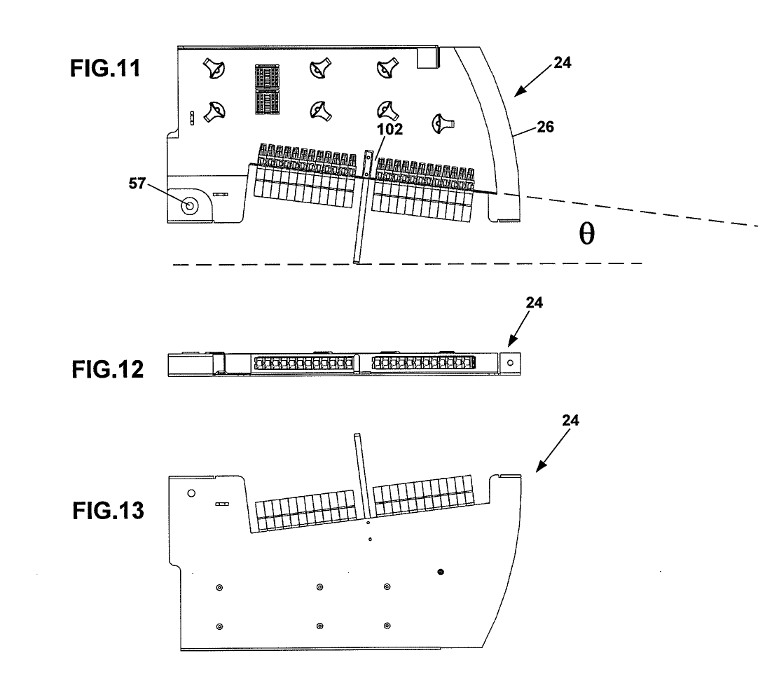

The splice tray support 26 of the splice shelf 24 is pivotally connected to the chassis 22 at a vertical pivot axis 57 located adjacent the front left corner of the chassis 22. As best shown at FIGS. 11-15, the splice tray support 26 includes a base 59 having front edge 60, a rear edge 62, a left edge 64 and a right edge 66. A rear wall 68 projects upwardly from the rear edge 62. A tab 70 projects forwardly from the rear wall 68. A fastener 72 (a quick-release push-style fastener) is mounted to the tab 70 and is configured to detachably fasten the tray body 30 to the splice tray support 26. For example, the fastener 72 can releasably engage a corresponding opening 74 defined by a tab 75 provided on the tray body 30. The splice tray support 26 also includes a front tab 76 positioned at the front edge 60. A fastener 78 is mounted on a front tab 76. The fastener 78 preferably is configured to releasably connect with a corresponding opening in the chassis 22 such that the fastener 78 functions to releasably retain the splice tray support 26 in the stowed position. The right edge 66 of the base 59 of the splice tray support 26 is curved to provide clearance relative to the chassis 22 when the splice tray 28 is pivoted between the stowed and accessed orientations.

Referring to FIG. 15, the splice tray support 26 also includes cable management structures. For example, a cable tie-down 80 is provided adjacent the vertical pivot axis 57 for tying down a cable (e.g., an outside plant cable) that is routed into the splice tray 28 from the left side of the splice tray adjacent the pivot axis 57. The splice tray support 26 also includes a forwardly projecting cable management bar 82 that projects forwardly from the front edge 60 of the base 59 of the splice tray support 26.

Referring still to FIGS. 11-15, the tray body 30 of the splice tray 28 includes a base 83 having a left edge 84, a right edge 86, a front edge 88, and a back edge 90. An upright adapter mounting wall 92 is located adjacent the front edge 88 of the base 83. The adapter mounting wall 92 defines openings 94 in which the fiber optic adapters 32 are mounted. A rear upright wall 96 is positioned at the rear edge 90 of the base 83. Cable management structures are provided on the base 83. For example, a cable tie-down 95 is provided adjacent the left edge 84 of the base 83. Additionally, first, second, and third sets of bend radius limiters 97-99 are mounted on the base 83 of the tray body 30. The sets of bend radius limiters 97-99 are configured for allowing excess cable (e.g., outside plant cable) to be spooled for the purpose of storing the excess cable. The splice sleeve holder 34 is mounted between the first and second sets of bend radius limiters 97, 98. The splice sleeve holder 34 defines the plurality of slots for receiving and holding splice protection sleeves used to hold together optical fibers that have been spliced together. A typical splice sleeve can include a strength member, an inner meltable adhesive tube and a polyolefin outer tube. An example of a splice sleeve is disclosed at U.S. Pat. No. 5,731,051, which is hereby incorporated by reference in its entirety.

Referring to FIG. 15, the fiber optic adapters 32 are arranged in left and right banks or rows at the adapter mounting wall 92 of the tray body 30. A gap 102 (FIG. 13) is positioned between the two banks of adapters 32. The cable management bar 82 extends forwardly from the splice tray 26 at a position aligned with the gap 102 between the banks of adapters 32. As shown in FIG. 15, the splice tray 28 also includes a further bend radius limiter 104 located adjacent the right bank of fiber optic adapters.

In the depicted embodiment, the fiber optic adapters 32 are SC-type adapters, although the scope of the present disclosure is not limited to the use of SC-type adapters. Similar SC-type adapters have been described in detail in commonly owned U.S. Pat. No. 5,317,663, the disclosure of which is incorporated herein by reference. Generally, each of the adapters 32 is configured to snap within its corresponding opening provided in the adapter mounting wall 92. As shown in FIG. 17, each adapter 32 includes a central alignment sleeve 120 for receiving the ferrules of two fiber optic connectors desired to be interconnected together. The connectors are inserted within opposite ports 122, 124 of the adapter 32 with their corresponding ferrules inserted within the alignment sleeve 120. Clips 126 are provided for retaining the connectors within their respective adapter ports 122, 124.

To promote cable management, the adapter mounting wall 92 is angled relative to the front side of the chassis 22 so that the fiber optic adapters 32 face slightly toward a left side 42 of the chassis 22. In certain embodiments, the front adapter mounting wall 92 is aligned at an angle θ ranging from about 0 degrees to about 45 degrees. In some embodiments, the front adapter mounting wall 92 is aligned at an angle θ ranging from about 5 degrees to about 15 degrees. In one embodiment, the front adapter mounting wall 92 is aligned at an angle θ of about 7 degrees relative to the front side of the chassis 22 (see FIG. 11).

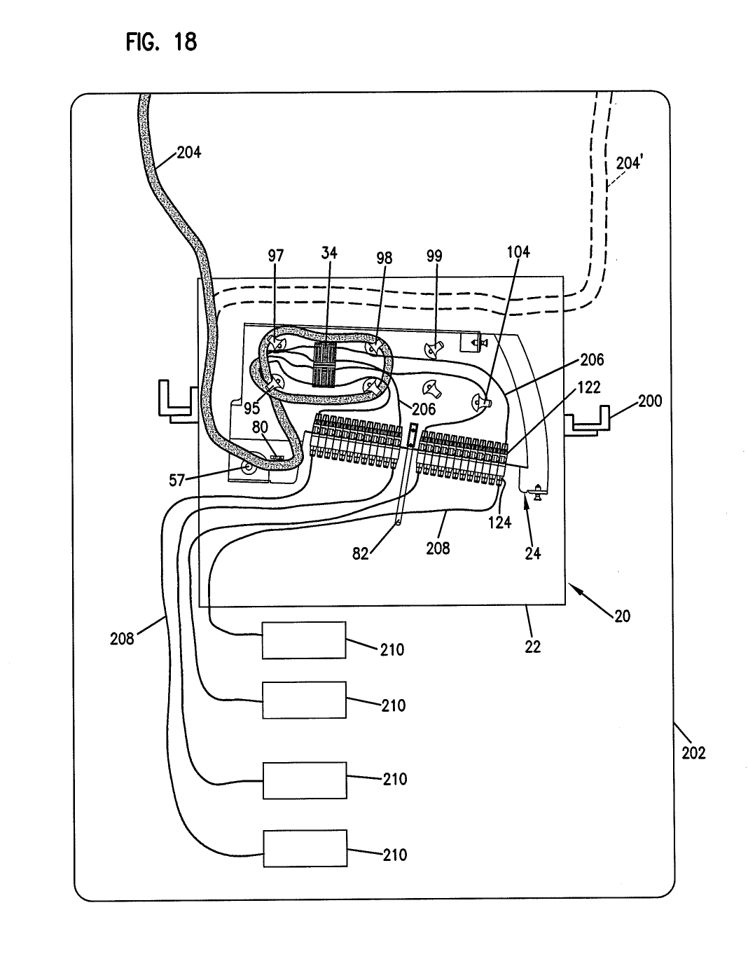

FIG. 18 is a schematic view showing a diagrammatic representation of an example cable routing scheme used within the fiber optic interconnection apparatus 20. In the embodiment of FIG. 18, the fiber optic interconnection apparatus 20 is mounted to a rack 200 position within an outside cabinet 202. An outside plant cable 204 (e.g., a 24 fiber cable) is routed into the cabinet 202 and into the left side of the fiber optic interconnection apparatus 20. Once inside the fiber optic interconnection apparatus 20, the outside plant cable 204 is routed in through the left side of the splice shelf 24 adjacent the pivot axis 57 and can be secured to tie-down 80 in conventional manner such as by using a tie-down strap. From the tie-down 80, the outside plant cable 204 can be looped around the radius limiters 97-99 so that excess cable can be stored in an efficient matter. In the depicted embodiment, the outside plant cable 204 is shown looped around the sets of bend radius limiters 97 and 98. If additional storage is required, the cable 204 can be looped around the bend radius limiters 97 and 99 so that the storage loop is increased in size. After looping around the bend radius limiters, the outside plant cable 204 can be tied down to tie-down 95 and fibers from the outside plant cable 204 can be routed to the splice sleeve holder 34 where the ends of the fibers of the outside plant cable 204 are spliced to pigtail fibers 206. The pigtail fibers 206 can be up-jacketed with buffer tubes (e.g., 900-micron buffer tubes) and are preferably terminated at their free ends with fiber optic connectors that are inserted into the ports 122 of the fiber optic adapters 32. The bend radius limiter 104 can assist in managing the pigtail fibers 206 that are routed to the right-most bank of fiber optic adapters 32.

The fiber optic adapters 32 preferably function to optically connect the pigtail fibers 206 to optical cords 208 that are optically connected to equipment 210 located within the cabinet 202. Preferably, the optical cords 208 have connectorized ends that are inserted within the ports 124 of the fiber optic adapters 32 so as to be optically connected to corresponding connectorized pigtails 206 located within the ports 122 of the adapters 32. The cable management bar 82 assists in preventing cords 208 routed from the left side of the chassis 22 to the right-most adapter bank from drooping as they extend across the front side of the fiber optic interconnection apparatus 20. The cable management bars 54, 56 of the chassis 22 assist in managing the cables 208 as the cables exit the fiber optic interconnection apparatus 20.

The arrangement of the splice shelf 24 assists in providing a relatively compact arrangement having at least twenty-four front accessible adapters that can fit within a 19 or 23 inch rack mount while still allowing for the efficient splicing of the fiber of the outside plant cable 204 to the connectorized pigtails 206. In one embodiment, the connectorized pigtails 206 are pre-inserted in the rear ports 122 of the adapters 32 at the time a fiber optic interconnection apparatus 20 is manufactured. In the field when it is desired to optically connect an outside plant cable 204 to the connecterized pigtails 206, the cable 204 is routed into the fiber optic interconnection apparatus 20 and the splice tray 28 is then pivoted from the stowed position to the accessed position. With the splice tray 28 in the accessed position, the tray body 30 is removed from the splice tray support 36 and splicing is preformed efficiently while the tray body 30 is separate from the splice tray support 36. After splicing has been accomplished, splice sleeves holding the splices are inserted into the splice sleeve holder 34 and the cable is routed on the tray body 30. Thereafter, the tray body 30 is reconnected to the splice tray support 26 and the splice tray 28 is pivoted from the accessed position back to the stowed position.

Referring still to FIG. 18, at times it is desirable for the outside plant cable 204 to enter the fiber optic interconnection apparatus 20 from the right side of the chassis 22. Outside plant cable 204′ shows a cable entering the chassis 22 through the right side. Once entering the chassis 22, the cable 204′ is routed along the backside of the chassis 22 and then follows the same path as the cable 204. The rear door 48 facilitates routing the cable 204′ along the backside of the chassis 22.

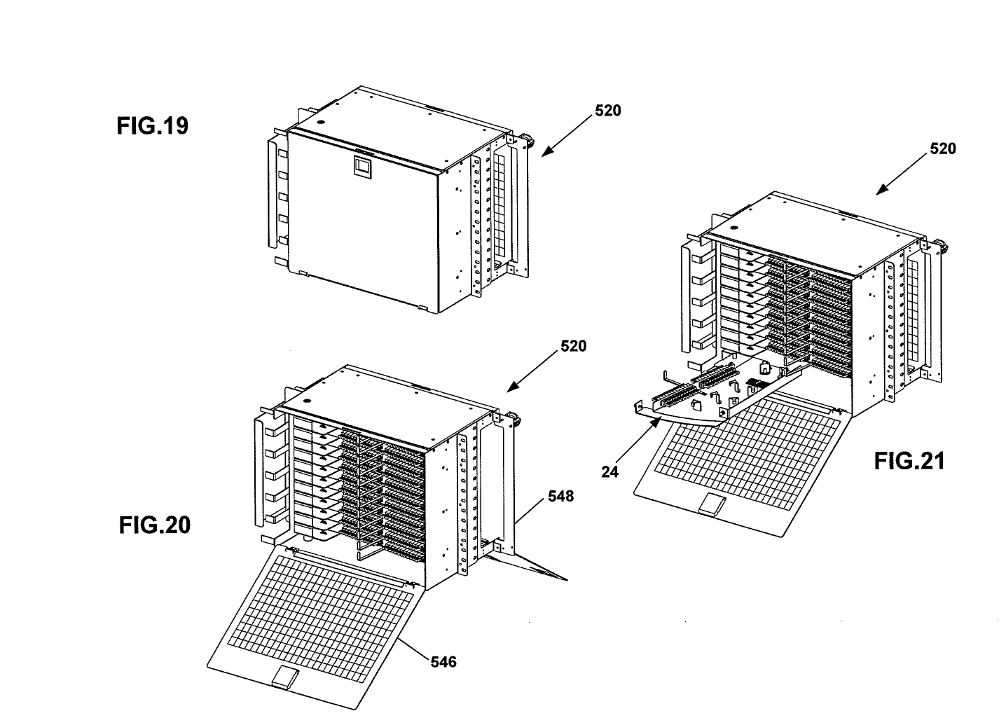

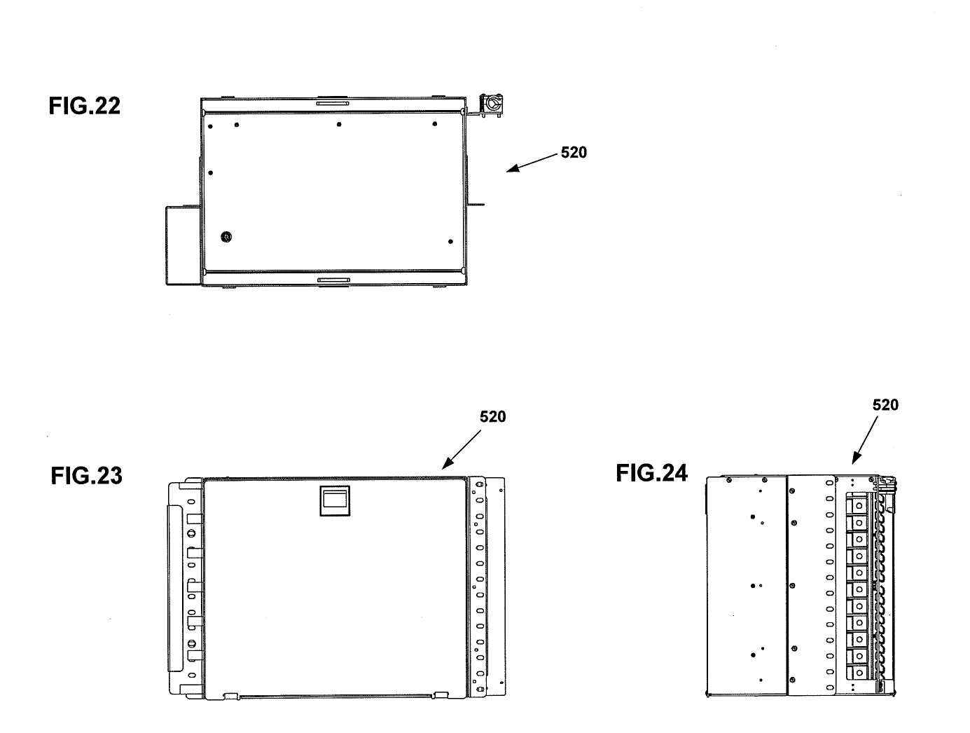

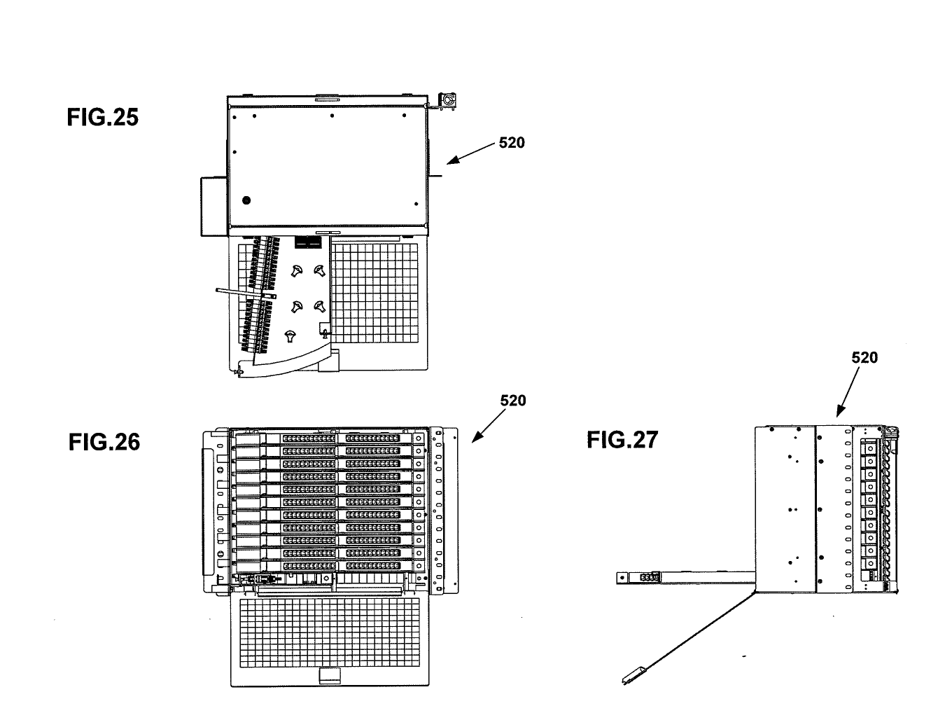

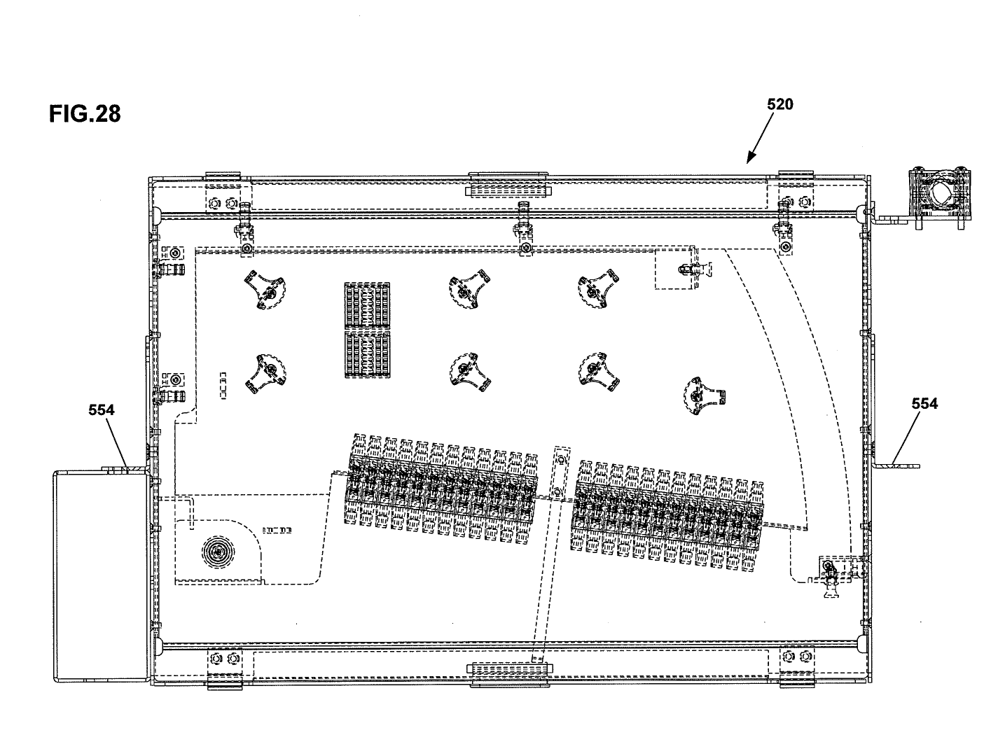

The embodiment of FIGS. 1-15 is depicted as a 24-port unit that occupies one rack unit height. It will be appreciated that other sized units also can be made in accordance with principles of the present disclosure. For example, other embodiments can include 72-port units that occupy three rack unit heights, 96-port units that occupy four rack unit heights, 144-port units that occupy six rack unit heights, 288-port units that occupy twelve rack unit heights, and 432-port units that occupy eighteen rack unit heights. FIGS. 19-28 show a fiber optic interconnection apparatus 520 that occupies twelve rack unit heights. The fiber optic interconnection apparatus 520 includes a chassis 522 sized to house twelve of the splice shelves 24. Similar to the previously described embodiment of FIGS. 1-15, the chassis 522 includes front and rear doors 546, 548 and left and right rack mounting flanges 554, 556. A vertical cable routing channel 600 is provided at the front left corner of the chassis 522. All of the splice trays 28 can be separately accessed from within the chassis 522 by moving any one of the splice trays 28 from the stowed position to an accessed position.

The above specification provides examples of how certain aspects may be put into practice. It will be appreciated that the aspects can be practiced in other ways than those specifically shown and described herein without departing from the spirit and scope of the present disclosure.

1. A fiber optic interconnection apparatus comprising:
a chassis;
at least one splice shelf pivotally mounted within the chassis, the splice shelf being pivotally movable from a stowed position within the chassis to an accessed position where the splice shelf is positioned at least partially outside the chassis, the splice shelf including a splice tray support pivotally connected to the chassis and a splice tray that removably mounts to the splice tray support, the splice tray including a tray body to which a plurality of fiber optic adapters are mounted, each fiber optic adapter defining a front port and a rear port, the splice tray also including a splice sleeve holder mounted to the tray body.

2. The fiber optic interconnection apparatus of claim 1, wherein the tray body of the splice tray is configured to receive a first bank of fiber optic adapters and a second bank of fiber optic adapters, the second bank being separated from the first bank by a gap.

3. The fiber optic interconnection apparatus of claim 2, wherein a cable management bar extends forwardly from the splice tray at a position aligned with the gap between the banks of fiber optic adapters, the cable management bar being connected to the splice tray support.

4. The fiber optic interconnection apparatus of claim 1, wherein the fiber optic adapters are mounted to an adapter mounting wall of the tray body, the adapter mounting wall being angled relative to a front side of the chassis.

5. The fiber optic interconnection apparatus of claim 4, wherein the adapter mounting wall is aligned at an angle of about 7 degrees relative to the front side of the chassis.

6. The fiber optic interconnection apparatus of claim 1, wherein the splice tray support of the splice shelf is pivotally connected to the chassis at a pivot axis located adjacent a front corner of splice tray support and a front corner of the chassis.

7. The fiber optic interconnection apparatus of claim 6, wherein an edge of the splice tray support is curved to provide clearance relative to the chassis when the splice tray is pivoted between the stowed and accessed orientations.

8. The fiber optic interconnection apparatus of claim 1, wherein the chassis also includes a front door and a rear door, each of the doors including a latch for retaining the door in a closed position.

9. The fiber optic interconnection apparatus of claim 1, wherein the splice tray includes cable management structures configured to store excess cable routed onto the splice tray.

10. The fiber optic interconnection apparatus of claim 9, wherein first, second and third sets of bend radius limiters are mounted on the tray body of the splice tray to store the excess cable.

11. The fiber optic interconnection apparatus of claim 10, wherein the bend radius limiters are arranged in two rows on the tray body.

12. The fiber optic interconnection apparatus of claim 1, wherein the splice tray is removably connected to the splice tray support by a fastener.

13. The fiber optic interconnection apparatus of claim 12, where the fastener is a quick-release push-type fastener.

14. The fiber optic interconnection apparatus of claim 1, wherein the splice shelf is configured to be releasably retained in the stowed position with respect to the chassis.

15. The fiber optic interconnection apparatus of claim 14, wherein the splice tray support includes a first tab to which a fastener is mounted, the fastener being configured to releasably connect with a corresponding opening in the chassis to releasably retain the splice shelf in the stowed position.

16. The fiber optic interconnection apparatus of claim 1, further comprising pigtails having connectorized ends that are pre-inserted into the rear ports of the fiber optic adapters.

17. The fiber optic interconnection apparatus of claim 1, wherein the splice tray support includes first and second sets of cable management bars that project forwardly from sides of the chassis to define slots, wherein the cable management bars manage fiber optic cables that are routed through one or more of the slots and onto the splice shelf.

18. The fiber optic interconnection apparatus of claim 1, wherein the at least one splice shelf includes a plurality of splice shelves that are pivotally mounted within the chassis, each of the splice shelves being configured to be accessed separately by moving the splice shelf from the stowed position to the accessed position.

19. A method of optically coupling a fiber optic cable to telecommunications equipment, the method comprising:
pivoting a splice shelf at least partially outside a chassis into an accessed position, the splice shelf including a splice tray and a splice tray support;
removing the splice tray from the splice tray support when the splice shelf is arranged in the accessed position;
splicing at least one fiber of a fiber optic cable to a pigtail fiber to create an optical splice, the pigtail fiber having a connectorized end that is received by a fiber optic adapter mounted to the splice tray, the fiber optic adapter being configured to optically couple the connectorized end of the pigtail to an optical cord that is optically connected to telecommunications equipment;
securing the optical splice to the splice tray;
reconnecting the splice tray to the splice tray support; and
pivoting the splice shelf from the accessed position to a stowed position within the chassis.

20. The method of claim 19, further comprising:
storing excess slack of the fiber optic cable by looping the excess slack around bend radius limiters mounted to the splice tray.
